(19) United States
(12) Patent Application Publication
(10) Pub. No.: US 2025/0117455 A1
(43) Pub. Date: Apr. 10, 2025

(54) SYSTEMS AND METHODS FOR PROTECTING A DIGITAL RIGHTS MANAGEMENT ("DRM")-PROTECTED CONTENT ELEMENT

(71) Applicant: Capital One Services, LLC, McLean, VA (US)

(72) Inventors: Joshua EDWARDS, Philadelphia, PA (US); Tyler MAIMAN, Melville, NY (US); Ian KATZMAN, Herndon, VA (US); Shahalam BAIG, Rochester, NY (US); Jackson WESTWOOD, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,272

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 40/117; G06F 40/143

(52) U.S. Cl. CPC G06F 21/106; G06F 40/117; G06F 40/143

(57) ABSTRACT

Described are systems and methods for dynamically protecting a digital rights management (“DRM”)-protected content element, including monitoring, via a browser module, on a first interval, DRM-protected media for impairment, the DRM-protected media having been caused to be output via a graphical user interface (“GUI”), wherein the DRM-protected media is associated with the DRM-protected content element, upon detecting impairment of the DRM-protected media, generating an indication of impairment via the browser module, based on the indication of impairment, obfuscating the DRM-protected content element via the browser module, and causing to output, via the GUI, the obfuscated DRM-protected content element.

### CROSS-REFERENCE TO RELATED APPLICATION(S)

This application claims the benefit of pending U.S. Provisional Patent Application No. 63/587,891 filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024,, all of which being incorporated herein by reference in their entireties.

### TECHNICAL FIELD

Various embodiments of this disclosure relate generally to dynamically protecting a DRM-protected content element and, more particularly, to systems and methods for dynamically protecting a DRM-protected content element from malfunctioning DRM protections.

### BACKGROUND

Organizations such as banks and healthcare providers seek to protect sensitive or confidential information (e.g., personally identifiable information (PII), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (DRM) technologies, which are technologies that limit the use of digital content. However, if the DRM technologies malfunction, the social engineer may still gain access to the account number or other sensitive information, which could put the user and the bank at risk.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically protecting a DRM-protected content element.

In one aspect, a method for dynamically protecting a digital rights management (“DRM”)-protected content element is disclosed. The method may include monitoring, via a browser module, on a first interval, DRM-protected media for impairment, the DRM-protected media having been caused to be output via a graphical user interface (“GUI”), wherein the DRM-protected media is associated with the DRM-protected content element, upon detecting impairment of the DRM-protected media, generating an indication of impairment via the browser module, based on the indication of impairment, obfuscating the DRM-protected content element via the browser module, and causing to output, via the GUI, the obfuscated DRM-protected content element.

In another aspect, a system is disclosed. The system may include at least one memory storing instructions and at least one processor operatively connected to the memory, and configured to execute the instructions to perform operations for dynamically protecting a DRM-protected content element. The operations may include monitoring, via a browser module, on a first interval, DRM-protected media for impairment, the DRM-protected media having been caused to be output via a graphical user interface (“GUI”), wherein the DRM-protected media is associated with the DRM-protected content element, upon detecting impairment of the DRM-protected media, generating an indication of impairment via the browser module, based on the indication of impairment, obfuscating the DRM-protected content element via the browser module, and causing to output, via the GUI, the obfuscated DRM-protected content element.

In another aspect, a method for dynamically protecting a digital rights management (“DRM”)-protected content element is disclosed. The method may include determining, via a browser module, a content element, wherein the content element is associated with sensitive information, tagging, via the browser module, HyperText Markup Language (“HTML”) associated with the content element, generating, via the browser module, media based on the content element and the tagged HTML, wherein the media is at least one of substantially transparent, 1 pixel by 1 pixel, or a single frame-looped video, encrypting, via the browser module, the media and the content element to generate the DRM-protected content element, causing to output, via a graphical user interface (“GUI”), the DRM-protected content element such that the DRM-protected media is overlaid on the content element, monitoring, via the browser module, on a first interval, the DRM-protected media for impairment, upon detecting impairment of the DRM-protected media, generating an indication of impairment via the browser module, based on the indication of impairment, obfuscating, via the browser module, the DRM-protected content element by modifying the tagged HTML via JavaScript® such that the content element is obfuscated from view when caused to be output via the GUI, and causing to output, via the GUI, the obfuscated DRM-protected content element.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically protecting a DRM-protected content element, according to one or more embodiments.

FIGS. 2A-2B depict exemplary methods for dynamically protecting a DRM-protected content element, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

The phrase “hypertext markup language,” “HTML,” or the like may refer to a standardized system for tagging text files to achieve font, color, graphic, or hyperlink effects on World Wide Web pages.

As used herein, the phrase “media content” may represent a browser, a website, a webpage, etc. As used herein, the phrase “content element” may represent text data, image data, audio data (e.g., a sequence of audio frames), or video data (e.g., a sequence of image frames). A content element may be included in HTML used to structure the website, such as a Document Object Model (“DOM”). In some aspects, the content element may include or represent sensitive or confidential information. As used herein, the phrase “sensitive information” may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

As used herein, the phrase “digital extraction” may refer to any process of copying content (e.g., audio, video, text, image, etc.), such as ripping, screensharing, screenshotting, etc. As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11® or an application accessed using a Print Screen key of a keyboard or keypad).

In an exemplary use case, if a DRM-protected video were to malfunction (e.g., by appearing as a transparent region or disappearing) when the display screen is screenshared or screenshotted, the content element may be at risk of being viewed by or shared with a social engineer. However, the embodiments described herein provide enhanced security (or backup protection) for the content element because the content element may be obfuscated in response to detecting that the transparent video (e.g., a 1 pixel by 1 pixel transparent video) has stopped playing (or that the display screen is being screenshared or screenshotted). As discussed herein, the dimensions of the transparent video (e.g., 1 pixel by 1 pixel) may be advantageous as it may significantly reduce the compute required to generate the transparent video with DRM protection(s).

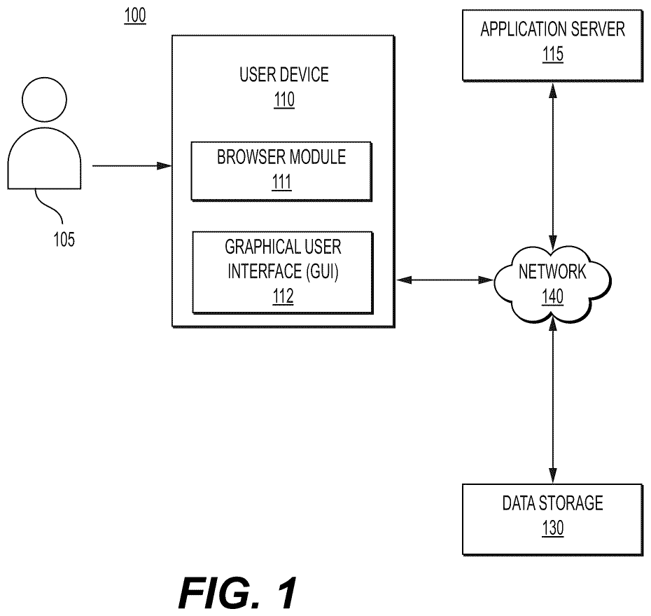

FIG. 1 depicts an exemplary environment 100 for dynamically protecting a digital rights management (“DRM”)-protected content element, according to one or more embodiments. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications is incorporated by reference herein in its entirety. Environment 100 may include one or more aspects that may communicate with each other over a network 140, including, e.g., at least one memory storing instructions, and at least one processor operatively connected to the at least one memory and configured to execute the instructions to perform operations for dynamically protecting a content element.

In some embodiments, a user 105 may interact with a user device 110 such that media content (e.g., a browser, a website, a webpage, etc.) including sensitive information may be loaded. As depicted in FIG. 1, a user 105 may be an individual authorized to use, access, etc. user device 110 or access, view, etc. the sensitive information discussed herein. User device 110 may interact with at least one of an application server 115, a data storage 130, etc.

In some embodiments, user device 110 may be a computer system, e.g., a desktop computer, a laptop computer, a tablet, a smart cellular phone, a smart watch or other electronic wearable, etc. In some embodiments, user device 110 may include one or more electronic applications, e.g., a program, plugin, browser extension, etc., installed on a memory of user device 110. In some embodiments, the electronic applications may be associated with one or more of the other components in the environment 100.

User device 110 may include a browser module 111 or a graphical user interface (“GUI”) 112. User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, data storage 130, etc. User device 110 may be configured to transmit data to one or more aspects of environment 100, e.g., to browser module 111, GUI 112 (e.g., via one or more inputs from user 105), application server 115, data storage 130, etc.

Browser module 111 may be configured to monitor DRM-protected media for impairment. In some embodiments, browser module 111 may be configured to determine whether the DRM-protected media failed to operate as expected or needed. For example, wherein the DRM-protected media is a single frame-looped video, browser module 111 may be configured to detect if the video has stopped playing, looping, etc.

Browser module 111 may be configured to monitor DRM-protected media for impairment on an interval (e.g., a first interval, a second interval, etc.). The interval may be preset (e.g., may be a system standard) or may be customized (e.g., by a user). Interval customization may be based on security needs, user preference(s), system abilities, etc. The interval may be any relevant amount of time, such as every 50 milliseconds, 100 milliseconds, 150 milliseconds, 200 milliseconds, 250 milliseconds, 300 milliseconds, 350 milliseconds, etc. A first interval may be the interval at which browser module 111 is configured to analyze the DRM-protected media for impairment. A second interval, as discussed in more detail below, may be the interval at which browser module 111 is configured to analyze the DRM-protected media for correction.

Browser module 111 may be configured to monitor DRM-protected media for correction. In some embodiments, browser module 111 may be configured to determine whether the DRM-protected media is operating correctly or has resumed operating correctly after failing to operate as expected or needed. For example, wherein the DRM-protected media is a single frame-looped video, browser module 111 may be configured to detect if the video has resumed playing, looping, etc.

Browser module 111 may be configured to monitor DRM-protected media for correction on an interval (e.g., a first interval, a second interval, etc.). As discussed herein, a second interval may be the interval at which browser module 111 is configured to analyze the DRM-protected media for correction. In some embodiments, the first interval and the second interval may be substantially similar. For example, the first interval and the second interval may both be 250 milliseconds. In some embodiments, the first interval and the second interval may be substantially different. For example the first interval may be 200 milliseconds and the second interval may be 100 milliseconds.

Browser module 111 may be configured to generate an indication of impairment. In some embodiments, browser module 111 may be configured to generate the indication of impairment upon determining at least one of (i) the DRM-protected media has failed to operate as expected or needed or (ii) digital extraction is detected. For example, browser module 111 may be configured to determine that the DRM-protected media has stopped playing, looping, etc. Browser module 111 may be configured to detect digital extraction based on indirect measures of digital extraction. For example, browser module 111 may be configured to detect user input(s) that may be indicative of screenshotting, such as simultaneously pressing and releasing the lock button and the volume up button on a cellular phone. Based on the determination, browser module 111 may be configured to generate the indication of impairment.

In some embodiments, browser module 111 may be configured to generate the indication of impairment based upon receipt of a transmission, alert, notification, etc. from another aspect of environment 100 (e.g., from application server 115) that the DRM-protected media has failed to operate as expected or needed. For example, browser module 111 may be configured to receive an alert from application server 115 that the DRM-protected media has stopped playing, looping, etc. Based on the alert, browser module 111 may be configured to generate the indication of impairment.

Browser module 111 may be configured to generate an indication of correction. In some embodiments, browser module 111 may be configured to generate the indication of correction upon determining the DRM-protected media is operating correctly or has resumed operating correctly after failing to operate as expected or needed. For example, browser module 111 may be configured to determine that the DRM-protected media has resumed playing, looping, etc. Based on the determination, browser module 111 may be configured to generate the indication of correction.

In some embodiments, browser module 111 may be configured to generate the indication of correction based upon receipt of a transmission, alert, notification, etc. from another aspect of environment 100 (e.g., from application server 115) that the DRM-protected media is operating correctly or has resumed operating correctly after failing to operate as expected or needed. For example, browser module 111 may be configured to receive a notification from application server 115 that the DRM-protected media has resumed playing, looping, etc. Based on the notification, browser module 111 may be configured to generate the indication of correction.

Browser module 111 may be configured to receive data from other aspects of environment 100, such as from user device 110, GUI 112 (e.g., via one or more inputs from user 105), application server 115, data storage 130, etc. Browser module 111 may be configured to transmit data to other aspects of environment 100, such as to other aspects of environment 100, such as to user device 110, GUI 112, application server 115, data storage 130, etc.

GUI 112 may be configured to output media, DRM-protected media, a content element, a DRM-protected content element, an obfuscated DRM-protected content element, etc. GUI 112 may be configured to output any number or any combination of media (e.g., first media, second media, third media, etc.), DRM-protected media (e.g., first DRM-protect media, second DRM-protect media, third DRM-protect media, etc.), etc.

GUI 112 may be configured to receive data from other aspects of environment 100, such as from user device 110, browser module 111, application server 115, data storage 130, etc. GUI 112 may be configured to transmit data (e.g., at least one user input) to other aspects of environment 100, such as to user device 110, browser module 111, application server 115, data storage 130, etc.

Application server 115 may be configured to determine at least one content element. In some embodiments, application server 115 may be configured to determine a content element based on sensitive information. For example, application server 115 may be configured to detect personally identifiable information (“PII”) included in HyperText Markup Language (“HTML”). Upon detecting the PII, application server 115 may be configured to determine the PII is associated with a content element.

Application server 115 may be configured to tag HTML associated with the content element. Application server 115 may be configured to tag the HTML to indicate that the content of a first HTML element (e.g., the content element) should be obfuscated when the content element is displayed on a display screen (e.g., that is being screenshared or screenshotted). In some embodiments, application server 115 may be configured to tag an HTML element based on the determination that the HTML includes sensitive information.

Application server 115 may be configured to generate media. The media may be a single frame-looped video. The media may be one (1) pixel by one (1) pixel, which may significantly reduce the compute required to generate the transparent video with DRM protection(s) (e.g., in comparison to media that is greater than one (1) pixel by one (1) pixel. The media may be substantially transparent. For example, the media may be 70%-80%, 80%-90%, 90%-99%, etc. transparent. It may be advantageous for the media to be less than 100% transparent because the DRM protection techniques may fail to completely render media that is 100% transparent, and therefore may fail to effectively block the 100% transparent media if digital extraction is detected. In some embodiments, application server 115 may be configured to generate media based on the content element and the tagged HTML. For example, application server 115 may generate media based on the sensitive information, the tag of the HTML, the HTML element, etc.

Application server 115 may be configured to generate a DRM-protected content element. In some embodiments, application server 115 may be configured to generate the DRM-protected content element by encrypting at least one of the media or the content element to include digital rights management (“DRM”) protection. Encrypting at least one of the media or the content element with DRM protections may be configured to restrict the sensitive information from being shared or recorded (or captured) by screen sharing application(s), remote desktop application(s), or screenshotting application(s), for example.

The DRM-protected media may be configured to play on the display screen (e.g., via GUI 112), and when playing, appear as a substantially transparent region or window on the display screen when the display screen is not being (i) screen-shared using a screen sharing application such as a web conferencing agent or remote computing application, or (ii) captured (or recorded) using a screenshotting application. The DRM-protected media may also be configured to stop playing, and when not playing, appear as a substantially opaque region on the display screen when the display screen is shared using a screen sharing application or captured using a screenshotting application.

Application server 115 may be configured to obfuscate the DRM-protected content element. In some embodiments, application server 115 may be configured to obfuscate the DRM-protected content element upon receipt of the indication of impairment. In some embodiments, application server 115 may be configured to obfuscate the DRM-protected content element by modifying the tagged HTML via a Cascading Style Sheet (“CSS”) or JavaScript®. Application server 115 may be configured to modify the tagged HTML such that the content element is obfuscated from view when caused to be output via the GUI (e.g., GUI 112). Further, in some embodiments, one or more HTML elements that include sensitive or confidential information and that are used to structure the website may be hard-coded such that the sensitive or confidential information therein may be obfuscated if displayed on the display screen when the display screen is screenshared or screenshotted. For example, application server 115 may be configured to hard code the one or more HTML elements that include sensitive or confidential information by tagging the one or more HTML elements to be obfuscated. In another example, application server 115 may be configured to obfuscate certain HTML-coded elements, such as the text on actuators (e.g., buttons, toggles, etc.), the text on a webpage, the entire webpage, etc.

In some embodiments, application server 115 may be configured to modify the tagged HTML (e.g., via JavaScript®) by altering formatting associated with the DRM-protected content element. Application server 115 may be configured to alter the formatting such that the text color of the content element and the background color of a display screen substantially match. For example, if the display screen background color is white, application server 115 may be configured to modify (e.g., via JavaScript®) the content element formatting contained in the tagged HTML such that the content element text is also white.

In some embodiments, application server 115 may be configured to modify the tagged HTML by converting text associated with the DRM-protected content element to at least one of letters, numbers, or symbols. Application server 115 may be configured to use any combination of letters, numbers, or symbols. For example, if the content element contains the text “123-45-6789” representing a user's social security number, application server 115 may be configured to modify (e.g., via JavaScript®) the text of the content element contained in the tagged HTML to read “***-**-****” in the HTML and when caused to be output via a GUI (e.g., GUI 112).

In some embodiments, application server 115 may be configured to modify the tagged HTML (e.g., via JavaScript®) by modifying the content element to remove an accessibility element. Application server 115 may be configured to detect an accessibility element (e.g., an accessibility tag) associated with the content element (e.g., Alternative Text (“alt text”), Accessible Rich Internet Applications (“ARIA”), etc.). Application server 115 may be configured to remove the detected accessibility element in the tagged HTML (e.g., via JavaScript®)).

Application server 115 may be configured to cache-prior to modification of the tagged HTML-the data of the content element via a data storage system (e.g., via data storage 130). Cached data may include the data of the content element that was modified, removed, etc., the location of the data of the content element, etc. In some embodiments, application server 115 may be configured to transmit the data to a storage system (e.g., to data storage 130) for caching. For example, where the formatting of the text of the content element is modified via the tagged HTML is modified from black to white (e.g., to match the color of the display screen background), the formatting color value for the text (e.g., “black”) may be cached. In another example, where the text of the tagged HTML associated with the content element is modified from “123-45-6789” to “***-**-****,” the value “123-45-6789” may be cached. In a further example, where the tagged HTML associated with the content element is modified to remove an accessibility element, the accessibility element may be cached.

Application server 115 may be configured to deobfuscate the DRM-protected content element (e.g., the obfuscated DRM-protected content element). In some embodiments, application server 115 may be configured to deobfuscate the DRM-protected content element upon receipt of the indication of correction.

In some embodiments, application server 115 may be configured to deobfuscate the DRM-protected content element by modifying the tagged HTML (e.g., via JavaScript®). Application server 115 may be configured to modify the tagged HTML such that the content element is deobfuscated from view (e.g., the data associated with the content element is made visible) when caused to be output via the GUI (e.g., GUI 112).

In some embodiments, application server 115 may be configured to deobfuscate the DRM-protected content element by reversing the manner used to obfuscate. For example, if the content element was obfuscated via altering the formatting such that the text color of the content element and the background color of a display screen substantially match, application server 115 may be configured to alter the formatting such that the text color of the content element is changed to a color substantially distinct from the background color of the display screen. In other words, if the text and background were altered to both be white, application server 115 may be configured to alter the text to be black so that the text is visible (e.g., when caused to be output via GUI 112).

In another example, if the content element was obfuscated via converting the text associated with the DRM-protected content element to at least one of letters, numbers, or symbols, application server 115 may be configured to convert the DRM-protected content element back to the text. In other words, if the content element text was converted from “123-45-6789” to “***-**-****,” application server 115 may be configured to convert the text from “***-**-****” to “123-45-6789.”

In a further example, if the content element was obfuscated via modifying the tagged HTML to remove an accessibility element, application server 115 may be configured to modify the content element to add the accessibility element.

In some embodiments, application server 115 may be configured to deobfuscate the DRM-protected content element by retrieving the obfuscated data from a cache (e.g., data storage 130). For example, if the content element was obfuscated via altering the formatting such that the text color of the content element and the background color of a display screen substantially match, application server 115 may be configured to retrieve the formatting data from a cache (e.g., data storage 130) for deobfuscation. It should be noted that in some embodiments, browser module 111 may be configured to locally cache data (e.g., obfuscated data, deobfuscated data, etc.).

In another example, if the content element was obfuscated via converting the text associated with the DRM-protected content element to at least one of letters, numbers, or symbols, application server 115 may be configured to retrieve the text from a cache (e.g., data storage 130) for deobfuscation. In other words, if the content element text was converted from “123-45-6789” to “***-**-****,” application server 115 may be configured to retrieve “123-45-6789” from a cache (e.g., data storage 130) for deobfuscation.

In a further example, if the content element was obfuscated via modifying the tagged HTML to remove an accessibility element, application server 115 may be configured to retrieve the accessibility element from a cache (e.g., data storage 130) for deobfuscation.

It should be noted that browser module 111 may be configured to locally conduct at least one of the techniques described herein in relation to application server 115. For example, browser module 111 may be configured to locally determine at least one content element, tag HTML associated with the content element, generate media, generate a DRM-protected content element, obfuscate the DRM-protected content element, modify the tagged HTML, cache the data of the content element (e.g., obfuscated data, deobfuscated data, etc.), deobfuscate the DRM-protected content element, etc. using the techniques described herein.

Application server 115 maybe configured to obtain data from one or more aspects of environment 100. For example, application server 115 may be configured to receive data from user device 110, browser module 111, GUI 112 (e.g., via one or more inputs from user 105), data storage 130, etc. Application server 115 may be configured to transmit data to one or more aspects of environment 100, e.g., to user device 110, browser module 111, GUI 112 (e.g., via one or more inputs from user 105), data storage 130, etc.

Data storage 130 may be configured to cache media (e.g., first media, second media, etc.), DRM-protected media (e.g., first DRM-protected media, second DRM-protected media, etc.), data (as discussed herein), etc. Data storage 130 may be configured to receive for caching, receive for storage, store, retrieve from the storage, or transmit from the storage: media (e.g., first media, second media, etc.), DRM-protected media (e.g., first DRM-protected media, second DRM-protected media, etc.), data, etc. Data storage 130 may be configured to receive data from other aspects of environment 100, such as from user device 110, browser module 111, GUI 112 (e.g., via one or more inputs from user 105), application server 115, etc. Data storage 130 may be configured to transmit data to other aspects of environment 100, such as to user device 110, browser module 111, GUI 112 (e.g., via one or more inputs from user 105), application server 115, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, browser module 111 may be integrated in application server 115. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

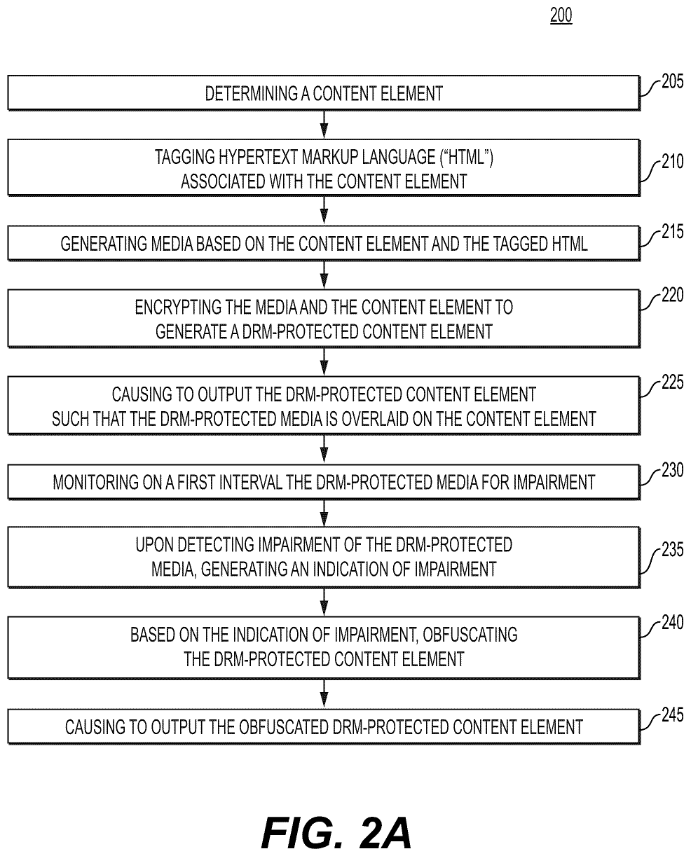

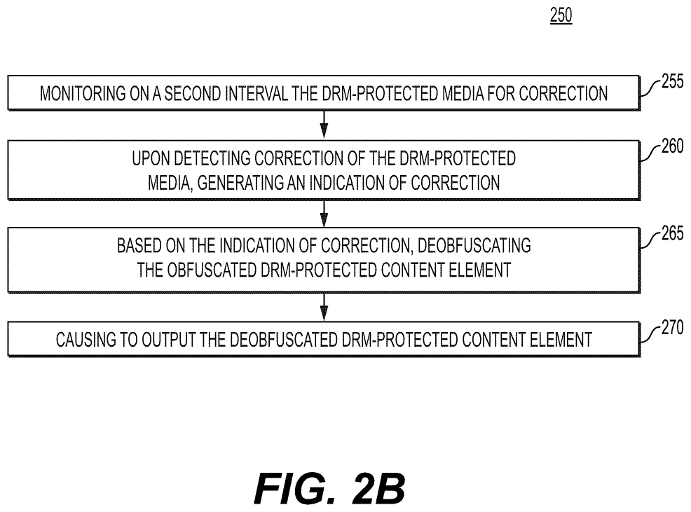

FIGS. 2A-2B depicts an exemplary method 200 for dynamically protecting a DRM-protected content element, according to one or more embodiments. This feature provides additional protection for sensitive information because, if digital extraction is detected and the DRM protections fail, the sensitive information may not be adequately protected absent this feature.

At step 205, as depicted in FIG. 2A, a content element may be determined (e.g., via application server 115). As discussed herein, the HTML may include a content element, and the content element may include sensitive information. In some embodiments, the HTML may be analyzed via the Document Object Model (“DOM”), the CSS, Javascript®, etc. In some embodiments, the HTML may be analyzed to determine at least one content element and sensitive information associated with each of the at least one content element. For example, if a user's (e.g., user 105) social security number is included in an HTML element, that HTML element may be determined to include the content element.

At step 210, the HTML associated with the content element may be tagged (e.g., via application server 115). Tagging the HTML may indicate that the content of a first HTML element (e.g., the content element) should be obfuscated when the content element is displayed on a display screen (e.g., that is being screenshared or screenshotted). In some embodiments, the HTML element may be tagged based on the determination that the HTML includes sensitive information.

In some embodiments, the operations may include tagging each of one or more other HTML elements (e.g., a second HTML element, a third HTML element, etc.) that may include sensitive or confidential content configured to be displayed on the display screen (e.g., via GUI 112). Tagging each of one or more other HTML elements (e.g., a second HTML element, a third HTML element, etc.) may indicate that such content should be obfuscated when presented on the display screen (e.g., if the display screen is being screenshared or screenshotted).

Further, in some embodiments, the operations may include tagging one or more HTML elements that include alt text or audio data, where the alt text or audio data represent sensitive or confidential information associated with the content element. In some aspects, such tagging may indicate that the alt text or audio data should be obfuscated (e.g., deleted or cached) when being processed by a screen reader (e.g., if the display screen is being screenshared or screenshotted).

At step 215, media may be generated based on the content element and the tagged HTML. As discussed herein, the media may be at least one of a single frame-looped video, one (1) pixel by one (1) pixel, substantially transparent, etc. For example, the media may be 70%-80%, 80%-90%, 90%-99%, etc. transparent. In some embodiments, the media may be generated (e.g., via application server 115) based on at least one of the content element, the HTML, the tagged HTML, etc. For example, the media may be generated as a single frame-looped video based on the sensitive information (e.g., a user's social security number), the tag of the HTML, the HTML element, etc.

In some aspects, the media may be included in a second HTML element used to structure the website. For example, the media (e.g., a single frame-looped video) may be generated (e.g., via application server 115) based on the first HTML element, and associated with the second HTML element. The second HTML element may be caused to be output (e.g., via GUI 112), as discussed below.

At step 220, the media and the content element may be encrypted to generate a DRM-protected content element. The DRM-protected content element may include DRM-protected media. For example, the operations may include, generating (e.g., via application server 115) a video (e.g., a single frame-looped video), where the video represents the content element and is protected using digital rights management technologies.

At step 225, the DRM-protected content element may be caused to be output via a GUI (e.g., GUI 112). In some embodiments, the operations may include displaying (e.g., via GUI 112) the DRM-protected content element on the display screen such that the DRM-protected media is overlaid on the content element.

In some aspects, the DRM-protected media may play on the display screen, and when playing, appear as a substantially transparent region or window on the display screen when the display screen is not being (i) screen-shared using a screen sharing application such as a web conferencing agent or remote computing application, or (ii) captured (or recorded) using a screenshotting application. In some aspects, the DRM-protected media may be configured to play (e.g., continually or in an infinite loop) on the display screen when the display screen is not being screenshared (e.g., using a screensharing application) or screenshotted (e.g., using a screenshotting application).

In some embodiments, the DRM-protected media may be displayed in a predetermined or fixed position on the display screen. In some aspects, the DRM-protected media may not overlap or hinder the rendering of the content element displayed on the display screen. Further, because the DRM-protected media may have dimensions of only 1 pixel by 1 pixel, the DRM-protected media may be played using relatively few processing and network bandwidth resources.

At step 230, the DRM-protected media may be monitored for impairment. For example, when the display screen is shared using a screen sharing application or captured using a screenshotting application, the DRM-protected video may stop playing erroneously or due to the detection of digital extraction and, when not playing, appear as a substantially opaque region on the display screen. If the DRM-protected media is determined to have stopped playing-either erroneously or due to digital extraction-it may be determined that the DRM-protected media is impaired.

In some embodiments, the DRM-protected media may be monitored for impairment (e.g., failure to play, loop, etc. or digital extraction) on a first interval. As discussed herein, the first interval may be the interval at which the DRM-protected media is analyzed for impairment (e.g., via browser module 111). For example, the first interval may be approximately 50 milliseconds, 100 milliseconds, 150 milliseconds, 200 milliseconds, 250 milliseconds, 300milliseconds, 350 milliseconds, etc.

At step 235, an indication of impairment may be generated (e.g., via browser module 111) upon detecting impairment of the DRM-protected media. The indication of impairment may include a predicted cause of impairment (e.g., an erroneous malfunction, digital extraction, etc.). For example, if the DRM-protected media (e.g., a single frame-looped video) is determined to have erroneously stopped playing, an indication of impairment may be generated indicating that the DRM-protected media may be impaired and the impairment may be due to a malfunction. In another example, if the DRM-protected media (e.g., a single frame-looped video) is determined to have stopped playing due to the presence of digital extraction, an indication of impairment may be generated indicating that the DRM-protected media may be impaired and the impairment may be due to digital extraction.

At step 240, the DRM-protected content element may be obfuscated based on the indication of impairment. For example, the operations may further include obfuscating (e.g., via application server 115) the DRM-protected content element (e.g., the tagged content element) in response to determining that the DRM-protected video has stopped playing. DRM-protected content element may be obfuscated by modifying the tagged HTML (e.g., via a Cascading Style Sheet (“CSS”), JavaScript®, etc.). The tagged HTML may be modified (e.g., via application server 115) such that the content element is obfuscated from view when caused to be output via the GUI (e.g., GUI 112).

In some embodiments, the tagged HTML may be modified (e.g., via the CSS, JavaScript®, etc.) by altering formatting associated with the DRM-protected content element. In some embodiments, the formatting may be modified (e.g., via application server 115) such that the text color of the content element and the background color of a display screen substantially match. For example, if the display screen background color is white, the content element formatting contained in the tagged HTML may be modified such that the content element text is also white.

In some embodiments, the tagged HTML may be modified (e.g., via JavaScript®) by converting text (e.g., letters, numbers, symbols, etc.) associated with the content element to at least one of letters, numbers, or symbols. Any combination of letters, numbers, or symbols may be used in the conversion. For example, if the content element contains the text “123-45-6789” representing a user's social security number, the text of the content element may be converted (e.g., via application server 115) to read “***-**-****” in the HTML and when caused to be output via a GUI (e.g., GUI 112).

In some embodiments, the tagged HTML may be modified (e.g., via JavaScript®) by removing an accessibility element. In some embodiments, the DRM-protected content element may be further obfuscated by deleting or caching an accessibility element (e.g., alt text, aria, audio data, etc.) in any HTML elements associated with the website, where the alt text or audio data may represent the content element. In some aspects, alt text may represent text configured to be read by a screen reader.

In some embodiments, the text, data, etc. that may be modified, removed, etc. when modifying the tagged HTML may be cached (e.g., via data storage 130). In other words, when the tagged content element of the first HTML element or the content of any other HTML elements are obfuscated, the original version (e.g., non-obfuscated version) of the tagged content element or the content of the other HTML elements may be cached (e.g., stored in a JavaScript variable of browser module 111). For example, where the formatting of the text of the content element is modified via the tagged HTML is modified from black to white (e.g., to match the color of the display screen background), the formatting color value for the text (e.g., “black”) may be cached. In another example, where the text of the tagged HTML associated with the content element is modified from “123-45-6789” to “***-**-****” the value “123-45-6789” may be cached. In a further example, where the tagged HTML associated with the content element is modified to remove an accessibility element, the accessibility element may be cached.

At step 245, the obfuscated DRM-protected content element may be caused to be output via a GUI (e.g., via GUI 112) (e.g., the obfuscated DRM-protected content element may be transmitted to GUI 112 for display or output). For example, where the formatting of the text of the content element is modified from black to white (e.g., to match the color of the display screen background), the white-text content element may be caused to be output. In another example, where the text of the tagged HTML associated with the content element is modified from “123-45-6789” to “***-**-****,” the content element may be caused to be output such that “***-**-****” is displayed on the display screen. In a further example, where the tagged HTML associated with the content element is modified to remove an accessibility element, the content element may be caused to be output without the accessibility element.

In some embodiments, the obfuscated DRM-protected content element may be deobfuscated, as depicted by method 250 of FIG. 2B. At step 255, the DRM-protected media may be monitored for correction. For example, it may be determined the DRM-protected media is operating correctly or has resumed operating correctly after failing to operate as expected or needed. For example, where the DRM-protected media is a single frame-looped video, it may be determined (e.g., via browser module 111) that the video has been corrected (e.g., is no longer impaired) if the video has resumed playing, looping, etc.

In some embodiments, the DRM-protected media may be monitored for correction (e.g., resumption of play, loop, etc. or the absence of digital extraction) on a second interval. The second interval may be the interval at which the DRM-protected media is analyzed for correction (e.g., via browser module 111). For example, the second interval may be approximately 50 milliseconds, 100 milliseconds, 150 milliseconds, 200 milliseconds, 250 milliseconds, 300 milliseconds, 350 milliseconds, etc.

As discussed herein, in some embodiments, the first interval and the second interval may be substantially similar. For example, the first interval and the second interval may both be 250 milliseconds. In some embodiments, the first interval and the second interval may be substantially different. For example the first interval may be 200 milliseconds and the second interval may be 100 milliseconds.

At step 260, an indication of correction may be generated (e.g., via browser module 111) upon detecting correction of the DRM-protected media. The indication of correction may include a predicted cause of correction (e.g., reversal of a malfunction, removal or absence of digital extraction, etc.). For example, if the DRM-protected media (e.g., a single frame-looped video) is determined to have resumed playing after erroneously stopping, an indication of correction may be generated indicating that the DRM-protected media may be corrected and the correction may be a self-correction. In another example, if the DRM-protected media (e.g., a single frame-looped video) is determined to have resumed playing due to a determination that digital extraction has ended or is not occurring, an indication of correction may be generated indicating that the DRM-protected media may be corrected and the correction may be due to the absence of digital extraction.

At step 265, the DRM-protected content element may be deobfuscated based on the indication of correction. For example, the operations may further include deobfuscating (e.g., via application server 115) the DRM-protected content element (e.g., the tagged content element) in response to determining that the DRM-protected video has resumed playing. The DRM-protected content element may be deobfuscated by modifying the tagged HTML (e.g., via a Cascading Style Sheet (“CSS”), JavaScript®, etc.). The tagged HTML may be modified (e.g., via application server 115) such that the content element is visible when caused to be output via the GUI (e.g., GUI 112). In other words, the DRM-protected content element may be deobfuscated by reversing the modification(s) conducted at step 240. In some embodiments, the

DRM-protected content element may be deobfuscated by retrieving the obfuscated data from a cache (e.g., browser module 111 or data storage 130).

In some embodiments, the DRM-protected content element may be deobfuscated by altering formatting associated with the DRM-protected content element. For example, if the content element was obfuscated via altering the formatting such that the text color of the content element and the background color of a display screen substantially match, the formatting may be altered (e.g., via browser module 111 or application server 115) such that the text color of the content element is changed to a color substantially distinct from the background color of the display screen. In other words, if the text and background were altered to both be white, the text may be altered to be black so that the text is visible when caused to be output via the GUI (e.g., GUI 112). In a further example, if the content element was obfuscated via altering the formatting such that the text color of the content element and the background color of a display screen substantially match, the formatting data may be retrieved (e.g., via application server 115) from a cache (e.g., browser module 111 or data storage 130) for deobfuscation.

In some embodiments, the DRM-protected content element may be deobfuscated by deconverting obfuscated text (e.g., letters, numbers, symbols, etc.) associated with the content element. For example, if the content element was obfuscated via converting the text associated with the DRM-protected content element to at least one of letters, numbers, or symbols, the DRM-protected content element may be converted (e.g., via application server 115) back to text, letters, etc. In other words, if the content element text was converted from “123-45-6789” to “***-**-****” the text may be converted from to “123-45-6789.” In a further example, if the content element was obfuscated via converting the text associated with the DRM-protected content element to at least one of letters, numbers, or symbols (e.g., to “***-**-****”), the text associated with the DRM-protected content element (e.g., “123-45-6789”) may be retrieved (e.g., via application server 115) from a cache (e.g., data storage 130) for deobfuscation.

In some embodiments, the DRM-protected content element may be deobfuscated by modifying the content element to return an accessibility element. For example, if the content element was obfuscated via modifying the tagged HTML to remove an accessibility element, the content element may be modified (e.g., via application server 115) to add the accessibility element. In a further example, if the content element was obfuscated via modifying the tagged HTML to remove an accessibility element, the removed accessibility element may be retrieved (e.g., via application server 115) from a cache (e.g., data storage 130) for deobfuscation.

At step 270, the deobfuscated DRM-protected content element may be caused to be output via a GUI (e.g., via GUI 112). For example, where the formatting of the text of the content element is deobfuscated from white to black, the black-text content element may be caused to be output. In another example, where the text of the tagged HTML associated with the content element is deobfuscated from “***-**-****” to “123-45-6789,” the content element may be caused to be output such that “123-45-6789” is displayed on the display screen. In a further example, where the tagged HTML associated with the content element is deobfuscated to add an accessibility element, the content element may be caused to be output with the accessibility element.

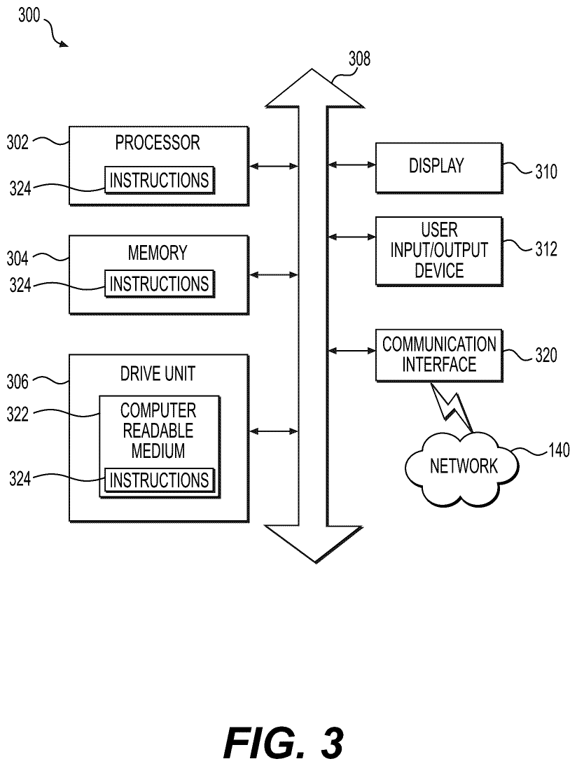

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks.

Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for dynamically protecting a digital rights management (“DRM”)-protected content element, the method comprising:
monitoring, via a browser module, on a first interval, DRM-protected media for impairment, the DRM-protected media having been caused to be output via a graphical user interface (“GUI”), wherein the DRM-protected media is associated with the DRM-protected content element;
upon detecting impairment of the DRM-protected media, generating an indication of impairment via the browser module;
based on the indication of impairment, obfuscating the DRM-protected content element via the browser module; and
causing to output, via the GUI, the obfuscated DRM-protected content element.

2. The method of claim 1, further comprising:
determining, via an application server, a content element, wherein the content element is associated with sensitive information;
tagging, via the application server, HyperText Markup Language (“HTML”) associated with the content element;
generating, via the application server, media based on the content element and the tagged HTML;
encrypting, via the application server, the media and content element to generate the DRM-protected content element; and
causing to output, via the GUI, the DRM-protected content element such that the DRM-protected media is overlaid on the content element.

3. The method of claim 2, wherein the media is at least one of substantially transparent, 1 pixel by 1 pixel, or a single frame-looped video.

4. The method of claim 2, wherein obfuscating the DRM-protected content element comprises:
modifying, via the application server, the tagged HTML via JavaScript® such that the content element is obfuscated from view when caused to be output via the GUI.

5. The method of claim 4, wherein modifying the tagged HTML comprises:
altering, via the application server, a formatting associated with the DRM-protected content element such that a text color of the DRM-protected content element and a background color of a display screen substantially match.

6. The method of claim 4, wherein modifying the tagged HTML comprises:
converting, via the application server, text associated with the DRM-protected content element to at least one of letters, numbers, or symbols; and
causing to output, via the GUI, the converted DRM-protected content element.

7. The method of claim 4, wherein modifying the tagged HTML comprises:
detecting, via the application server, an accessibility element associated with the content element;
modifying, via the application server, the content element to remove the accessibility element; and
causing to output, via the GUI, the modified content element.

8. The method of claim 1, wherein the first interval is every 250 milliseconds.

9. The method of claim 1, wherein monitoring the DRM-protected media for impairment further comprises:
determining, via the browser module, whether the DRM-protected media has stopped playing, wherein the DRM-protected media is a single frame-looped video; and
upon determining the DRM-protected media has stopped playing, generating the indication of impairment via the browser module.

10. The method of claim 1, further comprising:
monitoring, via the browser module, on a second interval the DRM-protected media for correction;
upon detecting correction of the DRM-protected media, generating an indication of correction via the browser module;
based on the indication of correction, deobfuscating the obfuscated DRM-protected content element via an application server; and
causing to output, via the GUI, the deobfuscated DRM-protected content element.

11. A system, the system comprising:
at least one memory storing instructions; and
at least one processor operatively connected to the memory, and configured to execute the instructions to perform operations for dynamically protecting a DRM-protected content element, the operations including:
monitoring, via a browser module, on a first interval, DRM-protected media for impairment, the DRM-protected media having been caused to be output via a graphical user interface (“GUI”), wherein the DRM-protected media is associated with the DRM-protected content element;
upon detecting impairment of the DRM-protected media, generating an indication of impairment via the browser module;
based on the indication of impairment, obfuscating the DRM-protected content element via the browser module; and
causing to output, via the GUI, the obfuscated DRM-protected content element.

12. The system of claim 11, wherein the operations further include:
determining, via an application server, a content element, wherein the content element is associated with sensitive information;
tagging, via the application server, HyperText Markup Language (“HTML”) associated with the content element;
generating, via the application server, media based on the content element and the tagged HTML;
encrypting, via the application server, the media and content element to generate the DRM-protected content element; and
causing to output, via the GUI, the DRM-protected content element such that the DRM-protected media is overlaid on the content element.

13. The system of claim 12, wherein the media is at least one of substantially transparent, 1 pixel by 1 pixel, or a single frame-looped video.

14. The system of claim 12, wherein obfuscating the DRM-protected content element comprises:
modifying, via the application server, the tagged HTML via JavaScript® such that the content element is obfuscated from view when caused to be output via the GUI.

15. The system of claim 14, wherein modifying the tagged HTML comprises:
altering, via the application server, a formatting associated with the DRM-protected content element such that a text color of the DRM-protected content element and a background color of a display screen substantially match.

16. The system of claim 14, wherein modifying the tagged HTML comprises:
converting, via the application server, text associated with the DRM-protected content element to at least one of letters, numbers, or symbols; and
causing to output, via the GUI, the converted DRM-protected content element.

17. The system of claim 14, wherein modifying the tagged HTML comprises:
detecting, via the application server, an accessibility element associated with the content element;
modifying, via the application server, the content element to remove the accessibility element; and
causing to output, via the GUI, the modified content element.

18. The system of claim 11, wherein monitoring the DRM-protected media for impairment further comprises:
determining, via the browser module, whether the DRM-protected media has stopped playing, wherein the DRM-protected media is a single frame-looped video; and
upon determining the DRM-protected media has stopped playing, generating the indication of impairment via the browser module.

19. The system of claim 11, further comprising:
monitoring, via the browser module, on a second interval the DRM-protected media for correction;
upon detecting correction of the DRM-protected media, generating an indication of correction via the browser module;
based on the indication of correction, deobfuscating the obfuscated DRM-protected content element via an application server; and
causing to output, via the GUI, the deobfuscated DRM-protected content element.

20. A method for dynamically protecting a digital rights management (“DRM”)-protected content element, the method comprising:
determining, via a browser module, a content element, wherein the content element is associated with sensitive information;
tagging, via the browser module, HyperText Markup Language (“HTML”) associated with the content element;
generating, via the browser module, media based on the content element and the tagged HTML, wherein the media is at least one of substantially transparent, 1 pixel by 1 pixel, or a single frame-looped video;
encrypting, via the browser module, the media and the content element to generate the DRM-protected content element;
causing to output, via a graphical user interface (“GUI”), the DRM-protected content element such that the DRM-protected media is overlaid on the content element;
monitoring, via the browser module, on a first interval, the DRM-protected media for impairment;
upon detecting impairment of the DRM-protected media, generating an indication of impairment via the browser module;
based on the indication of impairment, obfuscating, via the browser module, the DRM-protected content element by modifying the tagged HTML via JavaScript® such that the content element is obfuscated from view when caused to be output via the GUI; and
causing to output, via the GUI, the obfuscated DRM-protected content element.
